(19) United States
(12) Patent Application Publication
(10) Pub. No.: US 2018/0211280 A1
(43) Pub. Date: Jul. 26, 2018

(54) DETERMINING OPTIMAL SET OF NOTIFICATIONS FOR A CONSUMER WITHIN A VENUE

(71) Applicant: International Business Machines Corporation, Armonk, NY (US)

(72) Inventors: Lisa Seacat DeLuca, Baltimore, MD (US); Jeremy A. Greenberger, Raleigh, NC (US)

(21) Appl. No.: 15/410,944

(22) Filed: Jan. 20, 2017

(51) Int. Cl. G06Q 30/02; H04W 4/04; H04L 29/08; H04L 12/58

(52) U.S. Cl. CPC G06Q 30/0259; H04W 4/043; H04L 67/306; H04L 51/04; H04L 67/26

(57) ABSTRACT

Determining and sending an optimal set of notifications from a campaign for a consumer within a venue by determining a frequency count of notifications for the consumer within the venue based on criteria related to the consumer. Notifications applicable to the consumer are ranked based on criteria related to the consumer. Based on location events triggered by the consumer within the venue, notifications are sent to the user in ranked order until the number of notifications has not exceeded the frequency count determined for the consumer.

### BACKGROUND

The present invention relates to a notification system, and more specifically to a notification system which determines the optimal set of notifications to be sent to a consumer within a venue.

Notifications are any message that a user can receive on their device in real time. For example, push notifications, short message service (SMS) messages, multimedia messaging service (MMS) messages, and other messages.

Push notifications have a dramatic effect on an application's ability to engage users. Currently the marketers attempt to use push messaging in a way that does not anger the consumers. In a location or venue which uses location events and/or beacon technology, the tracking of users through location events can require the marketers to track a large number of various promotions to engage the users. Location events can be used to enhance current campaign capabilities for consumers within a venue through an application.

About 46% of users will opt-out of push notifications if they are sent two to five notifications per week. Another 32% of users will stop using the application altogether if they receive between six and ten push notifications in a week.

### SUMMARY

According to one embodiment of the present invention, a method of determining and sending an optimal set of notifications for a consumer within a venue is disclosed. The method comprising the steps of: a computer verifying that the consumer entered the venue; the computer determining a frequency count of notifications for the consumer within the venue based on criteria related to the consumer; the computer ranking notifications for the venue within the frequency count determined for the consumer; the computer monitoring for location events within the venue triggered by the consumer; and the computer detecting a location event and sending a notification.

According to another embodiment of the present invention, a computer program product for determining and sending an optimal set of notifications for a consumer within a venue is disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: verifying, by the computer, that the consumer entered the venue; determining, by the computer, a frequency count of notifications for the consumer within the venue based on criteria related to the consumer; ranking, by the computer, notifications for the venue within the frequency count determined for the consumer; monitoring, by the computer, for location events within the venue triggered by the consumer; and detecting, by the computer, a location event and sending a notification.

According to another embodiment of the present invention a computer system for determining and sending an optimal set of notifications for a consumer within a venue is disclosed. The computer system comprising a computer comprising at least one processor, one or more memories, one or more computer readable storage media having program instructions executable by the computer to perform the program instructions. The program instructions comprising: verifying, by the computer, that the consumer entered the venue; determining, by the computer, a frequency count of notifications for the consumer within the venue based on criteria related to the consumer; ranking, by the computer, notifications for the venue within the frequency count determined for the consumer; monitoring, by the computer, for location events within the venue triggered by the consumer; and detecting, by the computer, a location event and sending a notification.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIG. 3 shows a flow diagram of a method of determining an optimal set of notifications for a consumer within a venue.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

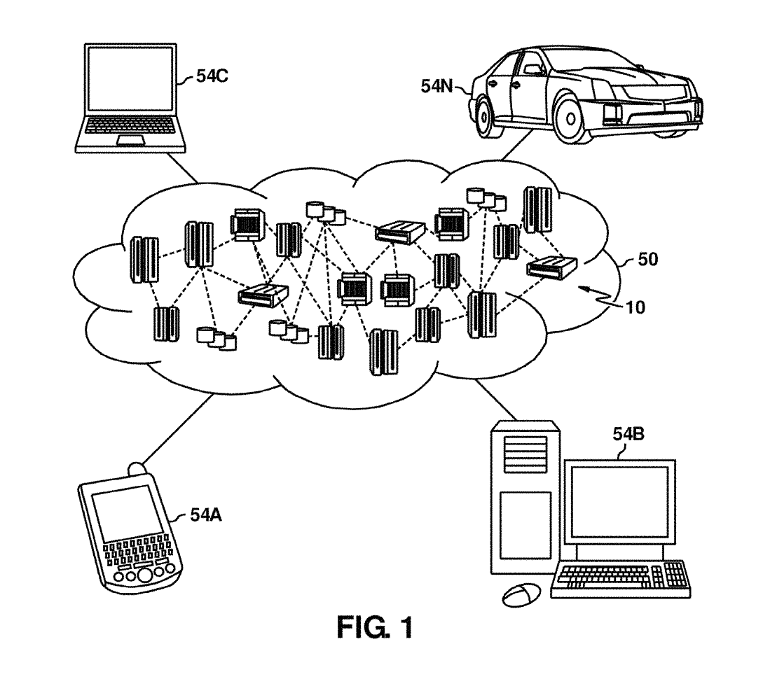

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

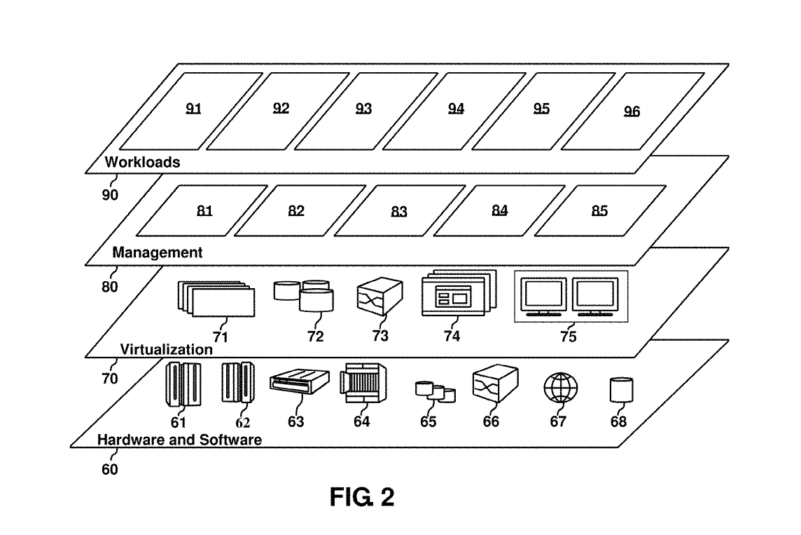

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and notification management system 96.

The notification system 96 can include a rules engine to reduce the number of notifications sent to users based on location events or types of location events and thus limit the amount of notifications passed onto the consumers based on criteria. Certain embodiments of the present invention utilize contextual and cognitive factors to determine the optimal set of notifications a device of a consumer should receive in order to maximize the user engagement without becoming annoying. The notification management system 96 allows for a configuration for a maximum amount of notifications to be set.

The notification management system 96 allows a company to specify any number of campaigns with notifications in a venue or location, and to limit the number of notifications of the campaigns a user is offered and to only retrieve the notifications that are most relevant to the user.

In embodiments of the present invention, a venue is configured for monitoring of a plurality of location events. The location events may be managed through a notification management system 96. The notification management system 96 can monitor for location events of the venue, such as zone entry, zone exit, zone dwell, geofence entry, geofence exit, and geofence dwell.

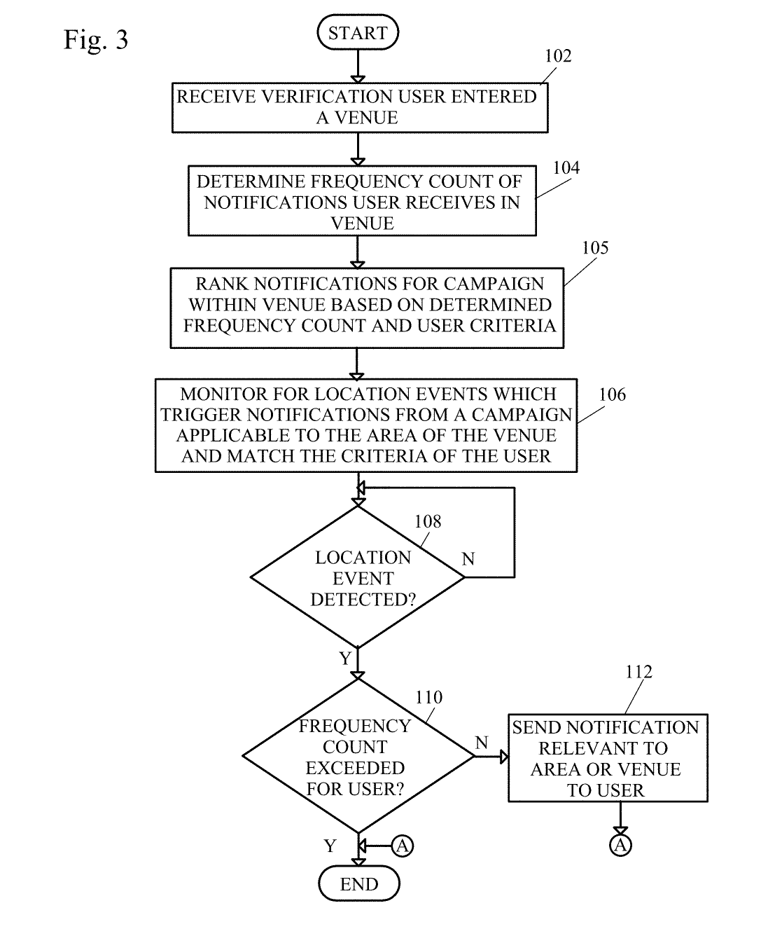

Prior to the method of FIG. 3, a venue is configured for location events and a notification management system 96 with associated campaign tools to consume location events is implemented. A floor plan of the venue is used to set designated areas. The location events are assigned to different designated areas of the venue. Entrance and exit of consumers to and from the areas of the venue are monitored by sensing hardware which sends data to the notification management system 96. The designated areas can be defined as beacon zones or geofences. The associated campaign tools preferably include a listener for location events and a campaign to be executed based on specific location events. A program of the campaigns may be stored in a lookup table, repository, database or other storage. The notification management system 96, based on company criteria, can set a maximum number of notifications for each area within the venue. A total maximum number of notifications sent to a device computer of the user for the venue may also be set. The maximum number of notifications a user receives in a single visit to the venue is defined as frequency count.

Furthermore, users who participate in receiving campaigns need to establish a profile for the user. The profile may include information regarding the user which may include, but is not limited to demographics information, historical purchases made at the venue linked to the user, topics of interest identified by the consumer, browsing behavior—both online and when in the physical venue, electronic wish lists, electronic shopping lists, and social activity relative to products.

The demographics may further include what items are often of interest to individuals with similar demographics as the user.

If a profile is unavailable, a default profile can be used for shoppers of the venue.

FIG. 3 shows a flow diagram of a method of determining an optimal set of notifications for a consumer within a venue.

A verification that a user entered a venue is received (step 102). This may be determined through location services associated with the device computer of the user. Alternatively, the user entering the venue can be manually verified. In yet another embodiment, the user can be verified through the user of a camera.

A frequency count of notifications a user receives in a venue based on criteria related to the user is determined (step 104).

The notifications for campaigns within the venue are ranked based on the determined frequency count and user criteria (step 105).

Location events which trigger notifications from a campaign applicable to the area of the venue and match the criteria for the user are monitored (step 106).

When a location event is detected (step 108), and the frequency count for the user has not been exceeded (step 110), a notification relevant to the area and/or venue is sent to the user (step 112) and the method returns to step 108.

When a location event has not been detected (step 108), the method returns to step 108).

When a location event has been detected (step 108) and the frequency count for the user has been exceeded (step 110), the method ends. In an alternate embodiment, the device may receive all of the notifications that were not received when the user's frequency count has been exceeded when the user is moving towards or at the registers to pay for their purchases or is exiting the venue in an email message.

Example Use Case

User A is visiting a supermarket. The marketer for the supermarket has setup multiple campaigns for indoor activity such as zone entry events. If User A were to visit all of the zones inside of the supermarket, eight push notifications would be triggered. User A is in a user category where, if the User receives more than a certain number of push messages, the user will stop using an application associated with the venue and likely uninstall the application. Using historical information about User A, it is determined that the most likely campaign of interest to User A is the cereal aisle campaign. Rather than User A receiving all eight notifications, User A receives only one notification for the cereal aisle as soon as the User triggers the location event (e.g. entering the area or zone of cereal of the supermarket).

However, since the notification management system 96 has identified User A as someone who is receptive to as many as three notifications, the notification management system 96 (i) re-ranks all the possible push notifications based on the determined frequency count and user criteria and (ii) based on that ranking determines which push notifications, included in the campaigns present for the venue of the supermarket, are most relevant to User A. Therefore, after a push notification that is most relevant to the user is sent, the remaining push notifications for the venue are sent to the user based on location events, until the maximum number of notifications for the user is received and the sending of notifications to the user is halted. In some embodiments, both the ranking and location events are used to determine which remaining push notifications are sent to the user until the maximum number of notifications for the user is received. For example, if a given location event is used for multiple different push notifications, then the push notification with the higher rank is sent to the user before push notifications with the lower rank until the maximum number of notifications for the user is received.

If User A were to visit the following zones: canned food zone, yogurt zone, bakery zone, ice cream zone, canned zone again, and cereal zone, with the present invention, User A would receive three notifications for canned foods, yogurt, and cereal. Even though User A entered the cereal zone last, because the notification was deemed most relevant to the User, it is given the highest priority and is one of the three notifications for the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of determining and sending an optimal set of notifications from a campaign for a consumer within a venue comprising the steps of:
a computer verifying that the consumer entered the venue;
the computer determining a frequency count of notifications for the consumer within the venue based on criteria related to the consumer;
the computer ranking notifications for the venue within the frequency count determined for the consumer;
the computer monitoring for location events within the venue triggered by the consumer; and
the computer detecting a location event and sending a notification.

2. The method of claim 1, wherein the criteria is based on information selected from the group consisting of: demographics information of the consumer, historical purchases made at the venue linked to the consumer, online browsing behavior of the consumer, browsing behavior of the consumer within the venue, topics of interest identified by the consumer, electronic wish lists of the consumer, electronic shopping lists of the consumer, and social activity of the consumer relative to products.

3. The method of claim 1, wherein the notifications most relevant to the consumer are included in the frequency count for the consumer.

4. The method of claim 1, wherein the notifications which were not sent to the consumer are sent to the consumer within an email message as the consumer exits the venue.

5. The method of claim 1, further comprising the step of: configuring a venue for location events and an associated campaign of promotions.

6. The method of claim 1, further comprising the step of: receiving criteria from the user to establish a profile for the user.

7. A computer program product for determining and sending an optimal set of notifications for a consumer within a venue, a computer comprising at least one processor, one or more memories, one or more computer readable storage media, the computer program product comprising a computer readable storage medium having program instructions embodied therewith, the program instructions executable by the computer to perform a method comprising:
verifying, by the computer, that the consumer entered the venue;
determining, by the computer, a frequency count of notifications for the consumer within the venue based on criteria related to the consumer;
ranking, by the computer, notifications for the venue within the frequency count determined for the consumer;
monitoring, by the computer, for location events within the venue triggered by the consumer; and
detecting, by the computer, a location event and sending a notification.

8. The computer program product of claim 7, wherein the criteria is based on information selected from the group consisting of: demographics information of the consumer, historical purchases made at the venue linked to the consumer, online browsing behavior of the consumer, browsing behavior of the consumer within the venue, topics of interest identified by the consumer, electronic wish lists of the consumer, electronic shopping lists of the consumer, and social activity of the consumer relative to products.

9. The computer program product of claim 7, wherein the notifications most relevant to the consumer are included in the frequency count for the consumer.

10. The computer program product of claim 7, wherein the notifications which were not sent to the consumer are sent to the consumer within an email message as the consumer exits the venue.

11. The computer program product of claim 7, further comprising program instructions of configuring, by the computer, a venue for location events and an associated campaign of promotions.

12. The computer program product of claim 7, further comprising program instructions of receiving, by the computer, criteria from the user to establish a profile for the user.

13. A computer system for determining and sending an optimal set of notifications for a consumer within a venue, the computer system comprising a computer comprising at least one processor, one or more memories, one or more computer readable storage media having program instructions executable by the computer to perform the program instructions comprising:
verifying, by the computer, that the consumer entered the venue;
determining, by the computer, a frequency count of notifications for the consumer within the venue based on criteria related to the consumer;
ranking, by the computer, notifications for the venue within the frequency count determined for the consumer;
monitoring, by the computer, for location events within the venue triggered by the consumer; and
detecting, by the computer, a location event and sending a notification.

14. The computer system of claim 13, wherein the criteria is based on information selected from the group consisting of: demographics information of the consumer, historical purchases made at the venue linked to the consumer, online browsing behavior of the consumer, browsing behavior of the consumer within the venue, topics of interest identified by the consumer, electronic wish lists of the consumer, electronic shopping lists of the consumer, and social activity of the consumer relative to products.

15. The computer system of claim 13, wherein the notifications most relevant to the consumer are included in the frequency count for the consumer.

16. The computer system of claim 13, wherein the notifications which were not sent to the consumer are sent to the consumer within an email message as the consumer exits the venue.

17. The computer system of claim 13, further comprising program instructions of configuring, by the computer, a venue for location events and an associated campaign of promotions.

18. The computer system of claim 13, further comprising program instructions of receiving, by the computer, criteria from the user to establish a profile for the user.
